(19) United States
(12) Patent Application Publication
(10) Pub. No.: US 2006/0207104 A1
(43) Pub. Date: Sep. 21, 2006

(54) Hair clipper with multiple speeds

(76) Inventors: Armando Alvite, Miami Lakes, FL (US); Octavio Alen, Boca Raton, FL (US)

Correspondence Address: Lawrence J. Shurupoff;Sunbeam Products, Inc., 2381 Executive Center Drive, Boca Raton, FL, 33431, US

(21) Appl. No.: 11/083,417

(22) Filed: Mar. 18, 2005

(51) Int. Cl. B26B 19/02

(52) U.S. Cl. 30/216

(57) ABSTRACT

A hair clipper has a housing in which a motor is disposed and blades at an end of the housing which the motor drives. The housing has a speed selector switch that extends through a wall of the housing and a controller disposed therein coupled to the switch and to the motor. The housing has associated with the speed selector switch a plurality of visual indicators. Each visual indicator is indicative of a particular type of animal. The speed selector switch is used to select the particular type of animal that the clipper will be used with. The controller is responsive to the selection of the animal type by the speed selector switch and sets the speed of the motor based on the particular type of animal selected. The visual indicators indicate which animal type was selected.

### FIELD OF THE INVENTION

The present invention relates to hair clippers, and more particularly, hair clippers used to clip the hair of different animals.

### BACKGROUND OF THE INVENTION

Grooming animals, such as pets or livestock, typically requires clipping the hair or fur of the animals being groomed. Electric clippers are typically used to do this. These electric clippers are typically one or two speed clippers. In two speed clippers, the second or lower speed is achieved by providing a lower voltage to the motor in the clipper. In such two speed clippers, the clipper typically just has a selector that the user switches between two settings typically designated as high or low, fast or slow, 1 or 2, or the like.

The hair of different species of animals, and sometimes of different breeds of the same species, has different characteristics. For example, cat hair has been found to have one of the higher tensile strengths among animal hairs. The optimum speed for clipping the hair of different species of animals (or different breeds of animals in the same species) may thus be different. One speed clippers, of course, gives the user no choice as to the speed to use. Two speed clippers only provide two speeds and the two speeds may not be optimal for all the different animals that the clipper may be used with. Further, since the two-speed clippers typically designated the speed settings as high or low, fast or slow, as discussed above, the user must learn and remember which speed setting should be used with which animal.

### SUMMARY OF THE INVENTION

A hair clipper in accordance with the invention has a housing in which a motor is disposed and blades at an end of the housing which the motor drives. The housing has a switch that extends through a wall of the housing and a controller disposed therein coupled to the switch and to the motor. The housing has associated with the switch a plurality of visual indicators. Each visual indicator is indicative of a particular type of animal. The switch can be a push-button or a selector switch and is used to select the particular type of animal that the clipper will be used with. The controller is responsive to the selection of the animal type by the switch and sets the speed of the motor based on the particular type of animal selected. The visual indicators indicate which animal type was selected.

In an aspect of the invention, the visual indicator is a light emitting type of device and the controller drives the visual indicator for the particular animal type selected to illuminate it.

In an aspect of the invention, the clipper has a temperature sensor, such as a thermistor, that senses the temperature of the blades of the clipper and provides a signal to the controller. The housing further has a temperature warning indicator that is illuminated by the controller if the temperature of the blades exceeds a predetermined level.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a multi-speed hair clipper in accordance with the invention;

FIG. 2 is a block diagram of the motor and motor control of the hair clipper of FIG. 1;

FIG. 3 is a flow chart of a control program that controls the hair clipper of FIG. 1; and

FIG. 4 is a perspective view of a variation of the multi-speed hair clipper of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

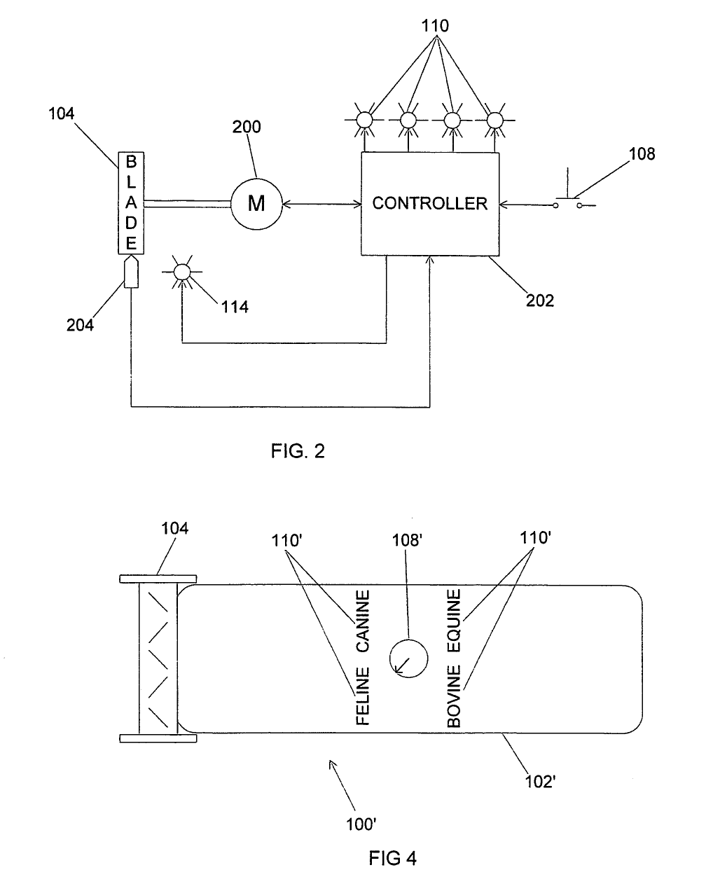

With reference to the drawings, a hair clipper 100 has a housing 102 in which a motor 200 (FIG. 2) and controller 202 are disposed. Motor 200 is coupled to blades 104 disposed at one end of housing 102. Hair clipper 100 further includes on-off switch 106 and speed selector switch 108, which are illustratively mounted in housing 102 at generally its middle so that they extend through a surface 109 of housing 102. On-off switch 106 turns power to motor 200 and controller 202 on and off in conventional fashion and speed selector switch 108 is used to select the speed at which hair clipper 100 operates as described below. Speed selector switch 108 may illustratively be a push-button switch and may be subsequently referred to as push-button switch 108 as well as speed selector switch 108. It should be understood that speed selector switch 108 may be other than a push-button switch, such as a multi-position switch with each position being for one of the speed settings.

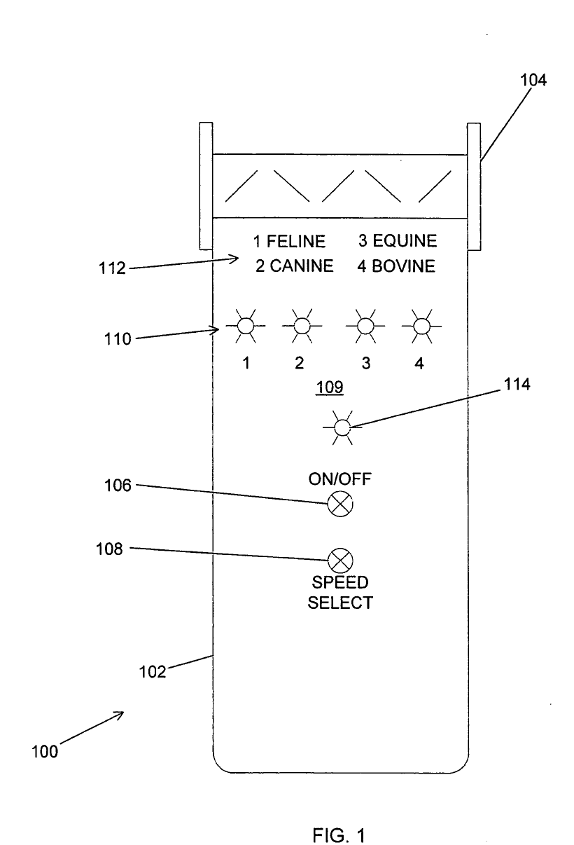

Hair clipper 100 further includes a plurality of indicators 110, which are illustratively mounted in housing 102 to extend through surface 109 of housing 102 adjacent blades 104. Indicators 110 are illustratively light emitting devices, such as light emitting diodes, lamps, fiber optic displays, or the like. In the illustrative embodiment shown in FIG. 1, each indicator 110 has a unique numerical designation (the numbers 1-4 as shown in FIG. 1) printed or otherwise placed on the surface 109 adjacent it. Alternatively, each indicator 110 may have a unique configuration, such as being shaped as a numeral. A legend 112 is also printed or otherwise placed on the surface of housing 102, illustratively adjacent indicators 110. In the illustrative embodiment of FIG. 1, the legend correlates each numerical designation to a type of animal, such as a species of animal, to identify the type of animal selected (as described below) when a particular indicator 110 is illuminated. In the illustrative embodiment shown in FIG. 1, the indicator labeled “1” when illuminated indicates that the speed for cutting feline hair has been selected, the indicator labeled “2” when illuminated indicates that the speed for cutting canine hair has been selected, the indicator labeled “3” when illuminated indicates that the speed for cutting equine hair has been selected and the indicator labeled “4” when illuminated indicates that the speed for cutting bovine hair has been illuminated.

Hair clipper 100 may further include a temperature sensor 204, such as a thermistor, mounted to or in proximity to blades 104 and a temperature warning indicator 114 mounted in housing 102 to extend through the surface 109 if housing 102. Temperature warning indicator 114 may illustratively be one or more light emitting diodes, lamps, other types of illuminated device, or could also be an audible device.

Motor 200 is illustratively a brushless DC motor and is controlled by controller 202 as a brushless DC motor in conventional fashion except as otherwise discussed herein. In this regard, controller 202 includes a programmable device, such as a microcontroller, also includes appropriate drive circuitry for driving motor 200 and illuminating visual indicators 110 and temperature warning indicator 114. The microcontroller may be a PIC16F872T-I/SS microcontroller available from Microchip Technology Inc., 2355 West Chandler Blvd., Chandler, Ariz., USA 85224-6199. Motor 200 is coupled to controller 202 to provide a speed feedback signal indicated by line 206. In this regard, controller 202 may derive the motor speed from one of the conventional position sensors of brushless DC motors that illustratively motor 200 has, such as a Hall effect transducer, that is coupled to controller 202 in conventional fashion.

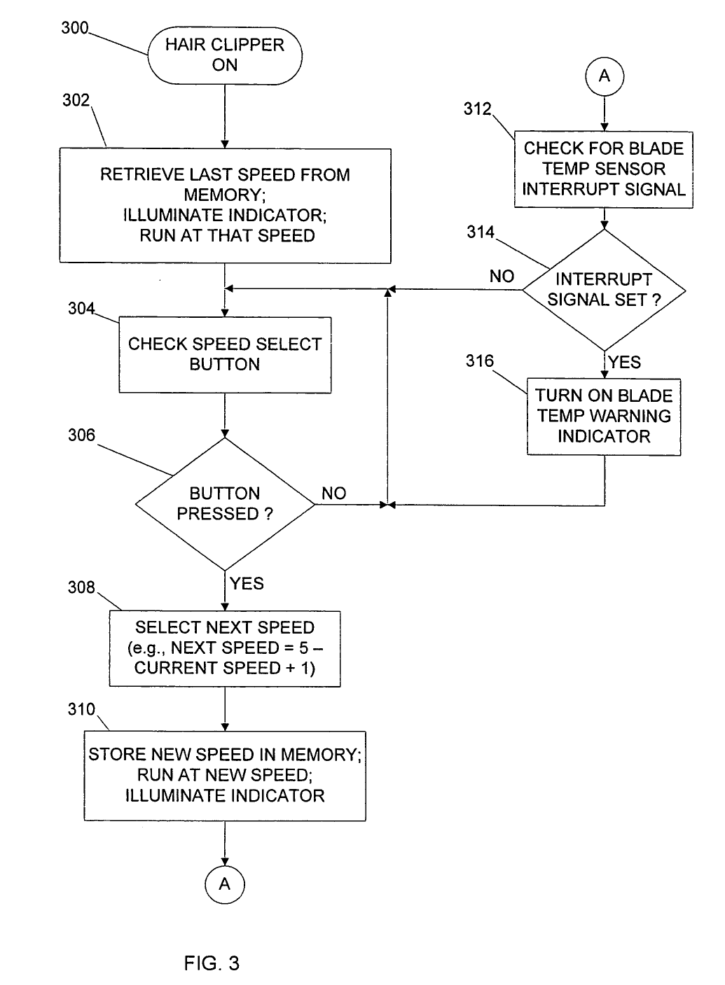

FIG. 3 shows a flow chart of an illustrative program for controller 202 for controlling motor 200 and hair clipper 100. When hair clipper 100 is turned on with on-off switch 106, the program starts at 300 and proceeds to block 302 where controller 202 retrieves from memory the last speed at which hair clipper 100 was operated and runs hair clipper 100 at that speed. It also illuminates the appropriate indicator 110. For example, if hair clipper 100 was last used to cut feline hair, controller 202 drives motor 200 to run at the programmed speed for feline hair and illuminates the indicate labeled “1” to provide a visual indication to the user that hair clipper 100 is running at the speed for cutting feline hair.

At 304, controller 202 checks speed selector switch 108 and at step 306, determines whether it was pressed. If not, it branches back to 304 where it checks speed selector switch 108. If so, it selects the next speed at 308. For example, if four speeds are available, controller 202 may use the simple algorithm of
Next Speed=5−Current Speed+1
to select the next speed. At 310, controller 202 stores this new speed in memory and illuminates the appropriate indicator 110 to indicate that hair clipper 100 is now being operated at this new speed.

The controller 202 then checks at 312 for an interrupt signal from temperature sensor 204. Illustratively, temperature sensor 204 is configured to provide an interrupt signal when the temperature of blades 104 exceeds a predetermined level. Controller next determines at 314 whether temperature sensor 204 set an interrupt signal. If not, it branches back to 304 where it checks speed selector switch 108. If so, it turns on temperature warning indicator 114 to indicate to a user of clipper 100 that blades 104 are too hot. It then branches back to 304 where it checks speed selector switch 108.

For example, if hair clipper 100 initially started running at the speed for feline hair, indicated by the visual indicator 110 labeled “1” and speed selector switch 108 is pressed, controller 202 then selects the next speed which is the speed for canine hair, stores this speed in memory and illuminates the indicator 110 labeled “2.” If the user wants the speed for bovine hair, the user then presses the speed selector switch 108 twice more, causing controller 202 to increment to the bovine speed setting, store this speed in memory and illuminate the indicator 110 labeled “4.” Since controller 202 is executing its program in the order of milliseconds or less, each time the user pushes speed selector switch 108 controller 202 appears to immediately index to the next speed. The user then simply presses the speed selector switch 108 the desired number of times to index to the desired speed.

Controller 202 is illustratively programmed with the optimum speed for the hair of each type of animal that can be selected. Thus, by pressing speed selector switch 108 the appropriate number of times, the user selects the animal whose hair is being cut and controller 202 then drives motor 200 at the optimum speed for cutting the hair of the selected animal.

While motor 200 is illustratively a brushless DC motor, it should be understood that other types of motors can be used, such as permanent magnet DC motors. If a permanent magnet DC motor used, controller 202 would illustratively be configured to control the permanent magnet DC motor in known fashion such as by outputting a pulse width modulated drive signal to the motor where the duty cycle is set based on the animal type selected. As is known, the speed of a permanent magnet DC motor driven with a pulse width modulated signal can be varied by varying the duty cycle of the pulse width modulated signal.

While indicators 110 are illustratively light emitting devices that are illuminated by controller 202 based on the animal type selected, it should be understood that other types of indicators could be used for indicators 110. For example, speed selector switch 108 could illustratively be a multi-position switch with each position associated with a particular one of the animal types, such as switch 108′ (FIG. 4). The indicators 110′ would illustratively then be located on the housing 102′ of hair clipper 100′ adjacent respective ones of the positions of speed selector switch 108′, and may be labels printed on the housing 102.′

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A multi-speed hair clipper, comprising:
a. a controller programmed with optimum speeds for cutting hair of a plurality of animal types;
b. a motor coupled to the controller and blades coupled to the motor;
c. a switch coupled to the controller to select among the plurality of animal types; and
d. the controller responsive to the selector switch to select from among the optimum speeds with which it is programmed the optimum speed for cutting the hair of the selected one of the plurality of animal types and driving the motor at that optimum speed.

2. The hair clipper of claim 1 including a light emitting visual indicator for each of the animal types, each visual indicator coupled to the controller, the controller illuminating the visual indicator for a particular animal type when that animal type is selected.

3. The hair clipper of claim 2 wherein the motor is a brushless DC motor.

4. The hair clipper of claim 1 including a temperature sensor coupled to the blades and electrically coupled to the controller, the controller illuminating a visual indicator upon determining in response to a signal from the temperature sensor that a temperature of the blades have exceeded a predetermined level.

5. A hair clipper, comprising:
a. a housing having a motor coupled to blades that project at an end of the housing;
b. a switch for selecting among a plurality of animal types to set the speed of the motor;
c. the motor responsive to the animal type selected by the selector switch and operating at the speed set by the selector switch;
d. the housing having a visual indicator that upon one of the animal types being selected by the selector switch, provides a visual indication of the animal type selected.

6. The hair clipper of claim 5 including a visual indicator for each animal type.

7. A multi-speed hair clipper for use with a plurality of animal types, comprising:
a. a housing;
b. blades at one end of the housing;
c. a motor received in the housing that drives the blades;
d. a switch for selecting the animal type;
e. a controller disposed in the housing and coupled to the switch and to the motor, the controller responsive to the switch and setting a speed of the motor based on the animal type selected with the switch; and
f. an indicator on the housing for each animal type that visually indicates the animal type selected with the switch.

8. The hair clipper of claim 7 including a temperature sensor coupled to the blades and electrically coupled to the controller, the controller illuminating a visual indicator in the housing upon determining in response to a signal from the temperature sensor that a temperature of the blades have exceeded a predetermined level.
